(19) United States
(12) Patent Application Publication
(10) Pub. No.: US 2023/0336032 A1
(43) Pub. Date: Oct. 19, 2023

(54) WIRELESS POWER TRANSMISSION DEVICE

(71) Applicant: LG ELECTRONICS INC., Seoul (KR)

(72) Inventors: Choonsub KIM, Seoul (KR); Seungil BEAK, Seoul (KR); Juhwan JEONG, Seoul (KR)

(73) Assignee: LG ELECTRONICS INC., Seoul (KR)

(21) Appl. No.: 18/040,105

(22) PCT Filed: Jul. 31, 2020
(86) PCT No.: PCT/KR2020/010144

§ 371 Date: Jan. 31, 2023

(51) Int. Cl. H02J 50/40; H02J 50/12; H02J 50/90; B60R 16/03

(52) U.S. Cl. CPC H02J 50/402; H02J 50/12; H02J 50/90; B60R 16/03

(57) ABSTRACT

This wireless power transmission device comprises a plurality of transmission coils and a control unit. The plurality of transmission coils are arranged along a single direction, in a matrix, or in a honeycomb shape. The control unit is controlled so that transmission power is transmitted to a wireless power receiving device from one or more transmission coils from among the plurality of transmission coils in accordance with the location of the wireless power receiving device placed on the plurality of transmission coils.

### TECHNICAL FIELD

Embodiments relate to a wireless power transmission device.

### BACKGROUND ART

A portable terminal such as a mobile phone or a laptop computer includes a battery for storing power and a circuit for charging and discharging the battery. In order to charge the battery of such a terminal, power has to be received from an external charger, that is, a wireless power transmission device.

In general, as an example of an electrical connection method between a charging device and a battery for charging power to the battery, there is a terminal supply method in which commercial power is supplied to be converted into a voltage and current corresponding to the battery so as to supply electrical energy to the battery through the terminal of the battery. The terminal supply method is accompanied by use of physical cables or wires. Therefore, when handling a lot of terminal supply type equipment, many cables occupy a considerable work space, are difficult to organize, and has a poor outer appearance. In addition, the terminal supply method may cause problems such as instantaneous discharge due to different potential differences between the terminals, burnout and fire caused by foreign substances, natural discharge, and degradation in lifespan and performance of the battery.

As a method of solving this problem, a wireless power transmission technology has recently been attracting attention.

Wireless power transmission or wireless energy transfer may be a technology that wirelessly transmits electrical energy from a transmitter to a receiver by using an induction principle of a magnetic field and be classified into a magnetic induction method, a magnetic resonance method, and an RF transmission method using a short-wavelength radio frequency.

The wireless power transmission technology may be used not only in mobile, but also in various industries such as IT, vehicles, railroads, and home appliance industries.

In general, a wireless power transmission device mounted on a vehicle includes a plurality of transmission coils, and only one transmission coil among the plurality of transmission coils may wirelessly transmit transmission power to the wireless power receiving device.

If the wireless power receiving device moves to an adjacent second transmission coil due to causes such as cornering or vibration of the vehicle, transmission of the transmission power from the first transmission coil is blocked, and then, the power is transmitted to the wireless power receiving device through only the adjacent second transmission coil after restarting. In this case, there is a problem in that charging of the wireless power receiving device is temporarily stopped after the transmission power from the first transmission coil is cut off until the transmission power from the second transmission coil is transmitted.

In addition, when the wireless power receiving device is a wearable device, a resonant frequency difference between the wireless power transmission device and the wearable device is large, and thus, charging efficiency is significantly deteriorated, and charging of the wearable device is not easy.

In addition, there is a dead zone in which the charging is not performed or a boundary zone in which the charging efficiency is deteriorated between the plurality of transmission coils, and thus, it is not easy to charge the wireless power receiving device disposed in this zone.

### DISCLOSURE OF THE INVENTION

### Technical Problem

An object of an embodiment is to solve the above and other problems.

Another object of an embodiment is to provide a wireless power transmission device capable of performing continuous charging without interruption even when a wireless power receiving device moves between transmission coils.

Further another object of an embodiment is to provide a wireless power transmission device capable of receiving the same transmission power even if the wireless power receiving device moves.

Further another object of an embodiment is to provide a wireless power transmission device capable of being easily charged even when a wireless power receiving device is disposed between adjacent transmission coils.

Further another object of an embodiment is to provide a wireless power transmission device capable of being easily charged even in an electronic device having a resonant frequency different from that of the wireless power transmission device, for example, a wearable device.

### Technical Solution

According to one aspect of an embodiment for achieving the above objects, a wireless power transmission device includes: a plurality of transmission coils; and a control unit, wherein the plurality of transmission coils are disposed in one direction, disposed in a matrix form, or disposed in a honeycomb shape. The control unit is configured to control transmission power to be transmitted from at least one or more transmission coils of the plurality of transmission coils to a wireless power receiving device according to a position at which the wireless power receiving device placed on the plurality of transmission coils is disposed.

According to another aspect of an embodiment, a vehicle includes the wireless power transmission device.

### Advantageous Effects

Effects of the wireless power transmission device according to the embodiment are described as follows.

According to at least one of the embodiments, even if the wireless power receiving device is disposed at any position of the transmission unit including the plurality of transmission coils, the received power received by the wireless power receiving device may always be obtained consistently, and thus, it may have the advantage of being easy to be charged regardless of the placement position of the wireless power receiving device.

According to at least one of the embodiments, even if the wireless power receiving device is disposed out of the specific transmission coil between the specific transmission coil and the adjacent transmission coil, the transmission power may be transmitted from both the specific transmission coil and the adjacent transmission coil, and the wireless power receiving device may receive the received power greater than that of the wireless power receiving device according to the related art by the transmitted power transmitted from each of the specific transmission coil and the adjacent transmission coil, and thus, there may be the advantage in that the charging of the wireless power receiving device is facilitated.

According to at least one of the embodiments, since the same charging efficiency is obtained in the central area of the transmission coil or in the boundary area between adjacent transmission coils, the user may not need to frequently check whether the wireless power receiving device is properly placed in the central area of the transmission coil, and thus, there may be the advantage in that the user's convenience is improved.

According to at least one of the embodiments, the charging area of the wireless power receiving device may be further expanded in the boundary area between the adjacent transmission coils, and thus, the wireless power receiving device may be charged in the wider charging area, as a result, there may be the advantage of enhancing the user convenience.

According to at least one of the embodiments, even if the first transmission coil moves to the second transmission coil, the transmission of the transmission power through the first transmission coil may be stopped, and the procedure for the restarting may not be performed, and thus, the transmission power may be transmitted through the corresponding transmission coil to which the wireless power receiving device moves. Therefore, since there is no occurrence of the period for which the transmission power is not transmitted, the charging of the wireless power receiving part may not be interrupted, and the charging may be facilitated, and thus, the information about the discontinuation of the charging may not be provided to the user to remove the inconvenience of the user.

The additional scope of the applicability of the embodiments will become apparent from the detailed description below. However, the various changes and modifications within the spirit and scope of the embodiments may be clearly understood by those skilled in the art, and thus, specific embodiments such as the detailed description and the preferred embodiments should be understood as given only as examples.

### BRIEF DESCRIPTION OF THE DRAWINGS

FIG. 1 is a view illustrating a state transition for explaining a wireless power transmission procedure defined in a WPC standard.

FIG. 2 is a block diagram illustrating a wireless power transmission device according to an embodiment.

FIG. 3 is a circuit diagram illustrating the wireless power transmission device according to an embodiment.

FIG. 4 is a view illustrating a first example of a plurality of transmission coils.

FIG. 5 is a view illustrating a second example of the plurality of transmission coils.

FIG. 6 is a flowchart for explaining an operation method of the wireless power transmission device according to an embodiment.

FIG. 7 is a view illustrating charging efficiency along line X1-X2 of FIG. 5 according to a comparative example and an embodiment.

FIG. 8 is a view illustrating a flux area according to a comparative example.

FIG. 9 is a view illustrating a flux area according to an embodiment.

FIG. 10 is a view illustrating charging efficiency according to a comparative example and an embodiment.

FIG. 11 is a view illustrating a state in which transmission power is transmitted through only a first transmission coil by turning on a first switch according to the comparative example.

FIG. 12 is a view illustrating a state in which transmission power is transmitted through first and second transmission coils by turning on first and second switches according to an embodiment.

FIG. 13 is a view illustrating charging efficiency at each coordinate near a boundary area between adjacent transmission coils.

FIG. 14 is a view illustrating a charging operation when a power transmission receiving device moves from a first transmission coil according to the comparative example.

FIG. 15 is a view illustrating a charging operation when a power transmission receiving device moves from a first transmission coil according to an embodiment.

FIG. 16 is a view illustrating a third example of the plurality of transmission coils.

FIG. 17 is a view illustrating a fourth example of the plurality of transmission coils.

FIG. 18 is a view illustrating a fifth example of the plurality of transmission coils.

FIG. 19 is a view illustrating a sixth example of the plurality of transmission coils.

FIG. 20 is a view illustrating a seventh example of the plurality of transmission coils.

FIG. 21 is a view illustrating an eighth example of the plurality of transmission coils.

FIGS. 22 to 25 are views illustrating various arrangements of the plurality of transmission coils of FIG. 18 in the fifth example.

FIG. 26 is a view illustrating a charging operation of a wearable device as the wireless power receiving device.

### MODE FOR CARRYING OUT THE INVENTION

Hereinafter, preferred embodiments of the present invention will be described below in more detail with reference to the accompanying drawings. However, the technical spirit of the present invention is not limited to some embodiments described, but may be implemented in various different forms, and within the technical spirit scope of the present invention, one or more of the components between the embodiments may be selectively coupled and substituted for the use. In addition, terms (including technical and scientific terms) used in the embodiments of the present invention, unless explicitly defined and described, can be generally understood by those skilled in the art to which the present invention pertains, and meanings of the terms, which are commonly used, such as predefined terms may be interpreted by considering the contextual meaning of the related technology. In addition, the terms used in the embodiments of the present invention are used only for explaining a specific exemplary embodiment while not limiting the present invention. In the present specification, a singular form may also include a plural form unless specifically stated in the phrase, and when described as “at least one (or more than one) of A, B, or C”, a combination of A, B, and C can contain one or more of all possible combinations. In the description of the components of the present invention, the terms first, second, A, B, (a), and (b) may be used. Each of the terms is merely used to distinguish the corresponding component from other components, and does not delimit an essence, an order or a sequence of the corresponding component. In addition, when any component is described as being ‘connected’, ‘coupled’ or ‘linked’ to another component, not only the component is directly connected, coupled, or linked to the other component, but also to the component is ‘connected’, ‘coupled’ or ‘linked’ by another component between the other components. In addition, when described as being formed or disposed in the “upper (top) or below (bottom)” of each component, the upper (top) or below (bottom) is not only when the two components are in direct contact with each other, but also a case in which another component described above is formed or disposed between the two components. In addition, when expressed as “upper (top) or below (bottom)”, it may include the meaning of the downward direction as well as the upward direction based on one component.

A wireless power transmission device according to an embodiment may be configured in a pad type, a mount type, an access point (AP) type, or the like.

A wireless power receiving device according to an embodiment may be used for small electronic devices, etc., such as mobile phones, smart phones, laptop computers, digital broadcasting terminals, personal digital assistants (PDAs), portable multimedia players (PMPs), navigation devices, MP3 players, electric toothbrushes, electronic tags, lighting devices, remote controls, fishing floats, and wearable devices such as smart watches, but is not limited thereto. Thus, any device is sufficient to be used as long as the wireless power transmission device according to an embodiment is mounted to charge a battery.

In an embodiment, the wireless power transmission device may include a plurality of transmission coils.

In an embodiment, the wireless power transmission device may be mounted on, for example, a vehicle. In this case, a diameters, e.g., an outer diameter, of each of a plurality of transmission coils of the wireless power transmission device may be greater than an outer diameter of each of receiving coils of the wireless power receiving device. For example, the outer diameter of each of the plurality of transmission coils of the wireless power transmission device may be greater twice or more than the outer diameter of each of the receiving coils of the wireless power receiving device, but is not limited thereto.

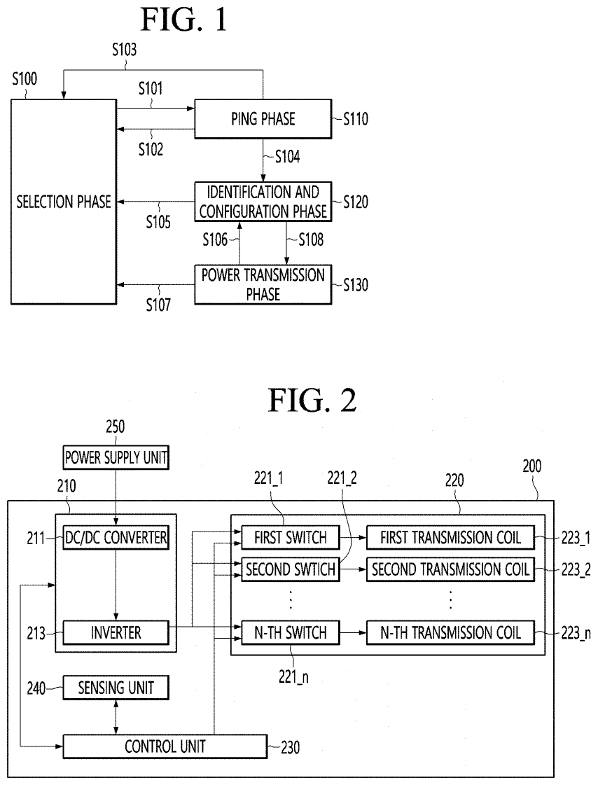

FIG. 1 is a view illustrating a state transition for explaining a wireless power transmission procedure defined in a WPC standard.

Referring to FIG. 2, power transmission from a transmitter to a receiver according to the WPC standard may be largely classified into a selection phase (S100), a ping phase (S110), an identification and configuration phase (S120), and a power transfer phase (S130).

The selection phase (S100) may be a phase in which transition is performed when a specific error or specific event is detected while the power transmission is started or maintained. Here, the specific error and specific event will become clear through the following description. In addition, in the selection phase (S100), the transmitter may monitor whether an object exists on an interface surface. If the transmitter detects that the object is placed on the interface surface, transition to the ping phase (S110) may be performed (S101). In the selection phase (S100), the transmitter may transmit an analog ping signal having a very short pulse to detect whether the object exists on an active area of the interface surface based on a current change in the transmission coil.

In the ping phase (S110), when the object is detected, the transmitter may activate the receiver to transmits the digital ping for identifying whether the receiver is a receiver compatible with the WPC standard. In the ping phase (S110), if the transmitter does not receive a response signal with respect to the digital ping (for example, a signal strength indicator) from the receiver, transition to the selection phase (S100) may be performed (S102). In addition, in the ping phase (S110), when the transmitter receives a signal that indicates the completion of the power transmission—that is, a charging completion signal—from the receiver, the transition to the selection phase (S100) may be performed (S103).

When the ping phase (S110) is completed, the transmitter may perform the transition to the identification and configuration phase (S120) for collecting receiver identification and receiver configuration and status information (S104).

In the identification and configuration phase (S120), the transmitter may perform the transition to the selection phase (S100) when an unexpected packet is received, the unexpected packet is not received for a predetermined time period (time out), a packet transmission error occurs, or a power transfer contract is not set (S105).

When the identification and configuration of the receiver is completed, the transmitter may perform transition to the power transmission phase (S130) of transmitting wireless power (S106).

In the power transmission phase (S130), the transmitter may perform the transition to the selection phase (S100) when the unexpected packet is received, the unexpected packet is not received for a predetermined time period (time out), a preset power transfer contract violation occurs, or the charging is completed (S107).

In addition, in the power transmission phase (S130), if the transmitter needs to reconfigure the power transfer contract according to a change in transmitter status, transition to the identification and configuration phase (S120) may be performed (S108).

The power transfer contract described above may be established based on state and characteristic information of the transmitter and the receiver. For example, the transmitter status information may include information on a maximum amount of transmittable power and information on the maximum number of receivers that are capable of being accommodated, and the receiver status information may include information on required power.

FIG. 2 is a block diagram illustrating the wireless power transmission device according to an embodiment.

Referring to FIG. 2, the wireless power transmission device 200 according to an embodiment may include a power conversion unit 210, a transmission unit 220, a control unit 230, and a sensing unit 240. It should be noted that the configuration of the wireless power transmission device 200 is not necessarily an essential configuration and may be configured to include more or fewer components.

When power is supplied from a power supply unit 250, the power conversion unit 210 may convert the power into power having a predetermined intensity. For this, the power conversion unit 210 may include a DC/DC converter 211 and an inverter 213. In FIG. 2, the power supply unit 250 is illustrated as being not included in the wireless power transmission device 200, but may be included in the wireless power transmission device 200.

The DC/DC converter 211 may perform a function of converting DC power supplied from the power supply unit 250 into DC power having a specific intensity according to a control signal of the control unit 230.

The control unit 230 may adaptively cut off the supply of the power from the power supply unit 250 or the supply of the power to the inverter 213 based on voltage/current values measured by the power sensing unit (not shown). For this, a predetermined power cutoff circuit may be further provided at one side of the power conversion unit 210 to cut off the power supplied from the power supply unit 250 or the power supplied to the inverter 213.

The inverter 213 may convert the DC/DC converted DC power into AC power. In addition, the inverter 213 may adjust an intensity of the converted AC power under the control of the control unit 230. That is, an output value output from the inverter 213 may be adjusted. The output value may be a voltage or power.

The transmission unit 220 may include first to n-th switches 221_1 to 221_n and first to n-th transmission coils 223_1 to 223_n.

The first to n-th switches 221_1 to 221_n may be switched so that an output power of the inverter 213 is transmitted to the first to n-th transmission coils 223_1 to 223_n.

The first to n-th transmission coils 223_1 to 223_n may transmit transmission power using the output power of the inverter to the wireless power receiving device. The first through n-th transmission coils may be referred to as antennas.

The control unit 230 may control the switches 221_1 to 221_n so that detection signals are simultaneously transmitted through the first to n-th transmission coils 223_1 to 223_n during the first detection signal transmission procedure. Here, the control unit 230 may identify timing, at which the detection signal is transmitted, through a detection signal transmission timer (not shown), and when the detection signal transmission timing arrives, the control unit 230 may control the switches 221_1 to 221_n so that the detection signal is transmitted through the corresponding transmission coil.

In addition, the control unit 230 may receive a predetermined transmission coil identifier for identifying through which transmission coil the signal strength indicator is received from a demodulation unit (not shown) during the first detection signal transmission procedure and a signal strength indicator received through the corresponding transmission coil. Subsequently, in the second detection signal transmission procedure, the control unit 230 may control the switches 221_1 to 221_n so that the detection signal is transmitted through only the transmission coil(s) into which the signal strength indicator is received during the first detection signal transmission procedure. As another example, if there are a plurality of transmission coils receiving the signal strength indicator during the first detection signal transmission procedure, the control unit 230 may determine the transmission coil receiving the signal strength indicator having the largest value as a transmission coil that transmits a detection signal in a second detection signal transmission procedure and then control the switches 221_1 to 221_n according to the determined result.

The wireless power transmission device 200 according to an embodiment includes a modulation unit (not shown) and a demodulation unit (not shown).

The modulation unit may modulate the control signal generated by the control unit 230 to transmit the modulated signal to the switches 221_1 to 221_n. Here, a modulation method for modulating the control signal may include a frequency shift keying (FSK) modulation method, a Manchester coding modulation method, a phase shift keying (PSK) modulation method, a pulse width modulation method, and the like.

When the signal received through the transmission coil is detected, the demodulation unit may demodulate the detected signal to transmit the demodulated signal to the control unit 230. Here, the demodulated signal may contain a signal control indicator, an error correction (EC) indicator for power control during wireless power transmission, an end of charge (EOC) indicator, an overvoltage/overcurrent/overheat indicator, etc., but is not limited thereto, and various state information for identifying the state of the wireless power receiving device may be contained.

In addition, the demodulation unit may identify from which transmission coil the demodulated signal is received and may provide a predetermined transmission coil identifier corresponding to the identified transmission coil to the control unit 230.

In addition, the demodulation unit may demodulate signals received through the transmission coils 223_1 to 223_n to transmit the demodulated signals to the control unit 230. For example, the demodulated signal may include a signal strength indicator, but is not limited thereto, and the demodulated signal may include various state information of the wireless power receiving device.

For example, the wireless power transmission device 200 may acquire the signal strength indicator through in-band communication that communicates with the wireless power receiving device using the same frequency used for the wireless power transmission.

In addition, the wireless power transmission device 200 may transmit wireless power using the transmission coils 223_1 to 223_n and also may exchange various information with the wireless power receiving device through the transmission coils 223_1 to 223_n. As another example, it should be noted that the wireless power transmission device 200 includes a separate coil corresponding to each of the transmission coils 223_1 to 223_n and performs the in-band communication with the wireless power receiving device using the provided separate coil.

The sensing unit 240 may check an overvoltage flowing through the power conversion unit 210 and the transmission unit 220 under the control of the control unit 230 and may sense the signal strength indicator received from the wireless power receiving device.

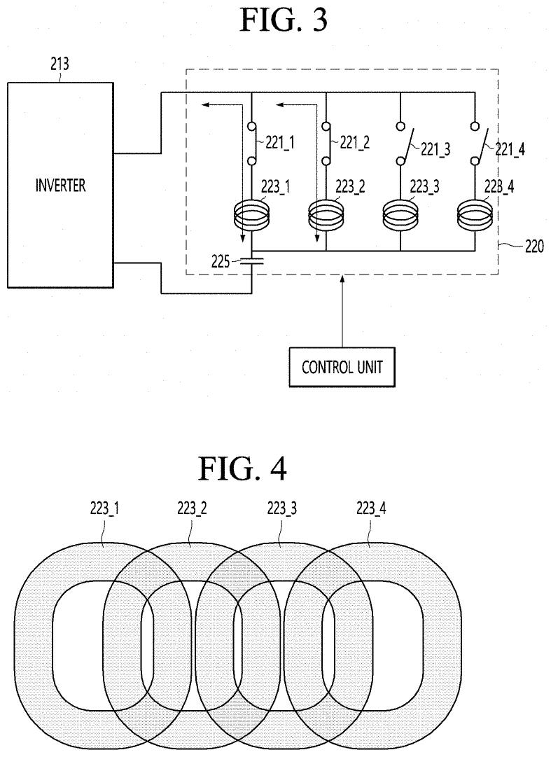

FIG. 3 is a circuit diagram illustrating the wireless power transmission device according to an embodiment.

Referring to FIG. 3, the wireless power transmission device according to an embodiment may include an inverter 213, a transmission unit 220, and a control unit 230.

The inverter 213 may convert the DC/DC converted DC power into AC power. In addition, the inverter 213 may adjust an intensity of the converted AC power under the control of the control unit 230. That is, an output value output from the inverter 213 may be adjusted.

The transmission unit 220 may transmit transmission power corresponding to an output of the inverter 213 to the wireless power receiving device.

The transmission unit 220 may include first to n-th switches 221_1 to 221_n and first to n-th transmission coils 223_1 to 223_n. Each of the first to n-th switches 221_1 to 221_n may be connected in series to the first to n-th transmission coils 223_1 to 223_n.

The first to n-th switches 221_1 to 221_n may be switched so that an output power of the inverter 213 is transmitted to the first to n-th transmission coils 223_1 to 223_n.

Each of the first to n-th transmission coils 223_1 to 223_n may be connected to the inverter 213 in parallel. That is, the first to n-th transmission coils 223_1 to 223_n may be connected in parallel to each other. For example, one side of each of the first to n-th transmission coils 223_1 to 223_n may be connected to a first side of an output terminal of the inverter 213, and the other side of each of the first to n-th transmission coils 223_1 to 223_n may be connected to a second side of the output terminal of the inverter 213.

The first to n-th transmission coils 223_1 to 223_n may transmit transmission power using the output power of the inverter 213 to the wireless power receiving device. The first to n-th transmission coils 223_1 to 223_n may be referred to as antennas.

The first to n-th transmission coils 223_1 to 223_n may be Litz wire coils, USTC wire coils, and the like. The first to n-th transmission coils 223_1 to 223_n may be patterned on a printed circuit board.

The control unit 230 may control the first to n-th transmission coils 223_1 to 223_n so that at least one or more transmission coils of the first to n-th transmission coils 223_1 to 223_n wirelessly transmit the transmission power according to an arrangement position of the wireless power receiver placed on the first to n-th transmission coils 223_1 to 223_n.

The control unit 230 may control the switches 221_1 to 221_n so that detection signals are simultaneously transmitted through the first to n-th transmission coils 223_1 to 223_n.

For example, when the wireless power receiving device is disposed on the first transmission coil 223_1 of the first to n-th transmission coils 223_1 to 223_n, the control unit 230 may turn on the first switch 221_1 connected to the first transmission coil 223_1 so that the output power of the inverter 213 is transmitted to the first transmission coil 223_1 through the first switch 221_1. The transmission power may be transmitted to the wireless power receiving device through the first transmission coil 223_1.

For example, when the wireless power receiving device is disposed between the first transmission coil 223_1 and the second transmission coil 223_2 among the first to n-th transmission coils 223_1 to 223_n, the control unit 230 may turn on the first and second switches 221_1 and 221_2, which are respectively connected to the first and second transmission coils 223_1 and 223_2 so that the output power of the inverter 213 is transmitted to the first and second transmission coil 223_1 and 223_2 through the first and second switches 221_1 and 221_2. The transmission power may be transmitted to the wireless power receiving device through each of the first and second transmission coils 223_1 and 223_2. The transmission power transmitted through the first transmission coil 223_1 and the transmission power transmitted through the second transmission coil 223_2 may be the same, but are not limited thereto.

The control unit 230 may acquire a position of the wireless power receiving device by using a response signal from the wireless power receiving device. The response signal may be referred to as a positioning signal. For example, the response signal may include signal strength information and a signal strength indicator. The response signal may include information about the received power received with respect to the transmission power transmitted through a specific transmission coil of the wireless power transmission device.

For example, the control unit 230 may acquire the position of the wireless power receiving device based on the signal strength indicator contained in the response signal from the transmission coil receiving the response signal among the plurality of transmission coils 223_1 to 223_n and may control the transmission coils 223_1 to 223_n so that the transmission power is transmitted through at least one transmission coil among the plurality of transmission coils 223_1 to 223_n according to the obtained arrangement position of the wireless power receiver.

For example, the wireless power transmission device may sequentially transmit a position request signal from each of the first to n-th transmission coils 223_1 to 223_n to the wireless power receiving device. The position request signal may be referred to as a detection signal. The wireless power receiving device may transmit a response signal to the wireless power transmission device in response to the position request signal. The position request signal may be a power signal.

For example, when the wireless power receiving device is disposed far from a specific transmission coil, the wireless power receiving device may not receive the position request signal transmitted from the specific transmission coil. In this case, the wireless power receiving device may not transmit the response signal to the wireless power transmission device. If the wireless power transmission device does not receive the response signal within a certain time period after transmitting the position request signal from the specific transmission coil, the wireless power receiving device may be considered to be disposed to be far apart and continues to turn off the switch connected to the specific transmission coil so that the transmission power is not transmitted to the wireless power receiving device.

For example, when the wireless power receiving device is disposed near the specific transmission coil, the wireless power receiving device may receive the position request signal transmitted from the specific transmission coil to transmit the response signal with respect to the position request signal to the wireless power transmission device. When the wireless power transmission device receives the response signal within a certain time period after transmitting the position request signal from the specific transmission coil, the wireless power transmission device may be considered to be disposed nearby the wireless power receiving device and to turn on the switch connected to the specific transmission coil so that the transmission power is transmitted to the wireless power receiving device.

For example, when the wireless power receiving device is disposed between the first transmission coil 223_1 and the second transmission coil 223_2, the wireless power receiving device may transmit the position request signal through the first transmission coil 223_1 and then transmit the position request signal through the 2 transmission coils 223_2. First, the wireless power receiving device may receive the position request signal from the first transmission coil 223_1 to transmit a response signal with respect to the position request signal to the wireless power transmission device. Subsequently, the wireless power receiving device may receive the position request signal from the second transmission coil 223_2 to transmit a response signal with respect to the position request signal to the wireless power transmission device. For example, since the wireless power transmission device receives the response signal with respect to the position request signal transmitted through the first transmission coil 223_1 and the response signal with respect to the position request signal transmitted through the second transmission coil 223_2 from the wireless power receiver, the wireless power receiving device may be disposed between the first transmission coil 223_1 and the second transmission coil 223_2 to turn on the first and second switches 221_1 and 221_2, which are connected to the first transmission coil 223_1 and the second transmission coil 223_2, respectively, so that the transmission power is transmitted to the wireless power receiving device through the first and second transmission coils 223_1 and 223_2, respectively.

In summary, when the wireless power receiving device is disposed on the specific transmission coil, the transmission power may be transmitted to the wireless power receiving device through the specific transmission coil.

When the wireless power receiving device is disposed between at least two or more transmission coils, the transmission power may be transmitted to the wireless power receiving device through each of the at least two or more transmission coils. Therefore, even if the wireless power receiving device is deviated from the specific transmission coil, and contribution of the received power by the transmission power transmitted through the specific transmission coil is reduced, the received power may be contributed by the transmission power transmitted from each of the at least one adjacent transmission coil. That is, even if the wireless power receiving device is deviated from the specific transmission coil, desired received power may be obtained by the transmission power transmitted from other adjacent transmission coils.

Thus, even if the wireless power receiving device is disposed at any position of the transmission unit 220 including the plurality of transmission coils 223_1 to 223_n, the received power received by the wireless power receiving device may always be obtained consistently and thus may be easily charged regardless of the placement position of the wireless power receiving device.

In particular, in the related art, when the wireless power receiving device is deviated from the specific transmission coil and disposed between the specific transmission coil and the adjacent transmission coil, the received power contributed by the transmission power may be reduced by being charged through the transmission power transmitted through the transmission coil, and as a result, the charging may not be facilitated. However, like this embodiment, even if the wireless power receiving device is disposed out of the specific transmission coil between the specific transmission coil and the adjacent transmission coil, the transmission power may be transmitted from both the specific transmission coil and the adjacent transmission coil, and the wireless power receiving device may receive the received power greater than that of the wireless power receiving device according to the related art by the transmitted power transmitted from each of the specific transmission coil and the adjacent transmission coil, and thus, the charging of the wireless power receiving device may be facilitated.

FIG. 4 is a view illustrating a first example of the plurality of transmission coils.

Although FIG. 4 illustrates four transmission coils 223_1 to 223_4, fewer or more transmission coils may be provided.

As illustrated in FIG. 4, the first to fourth transmission coils 223_1 to 223_4 may be disposed along one direction. Each of the first to fourth transmission coils 223_1 to 223_4 may have a circular or elliptical shape. Each of the first to fourth transmission coils 223_1 to 223_4 may be wound with a plurality of turns.

The first transmission coil 223_1 and the third transmission coil 223_3 may be disposed to be in contact with each other. The second transmission coil 223_2 and the fourth transmission coil 223_4 may be disposed to be in contact with each other.

For example, the first transmission coil 223_1 and the third transmission coil 223_3 may constitute a first layer, and the second transmission coil 223_2 and the fourth transmission coil 223_4 may constitute a second layer. The second layer may be disposed on the first layer.

For example, a portion of the second transmission coil 223_2 may vertically overlap a portion of the first transmission coil 223_1, and another portion of the second transmission coil 223_2 may vertically overlap a portion of the third transmission coil 223_3. For example, a portion of the fourth transmission coil 223_4 may vertically overlap another portion of the third transmission coil 223_3.

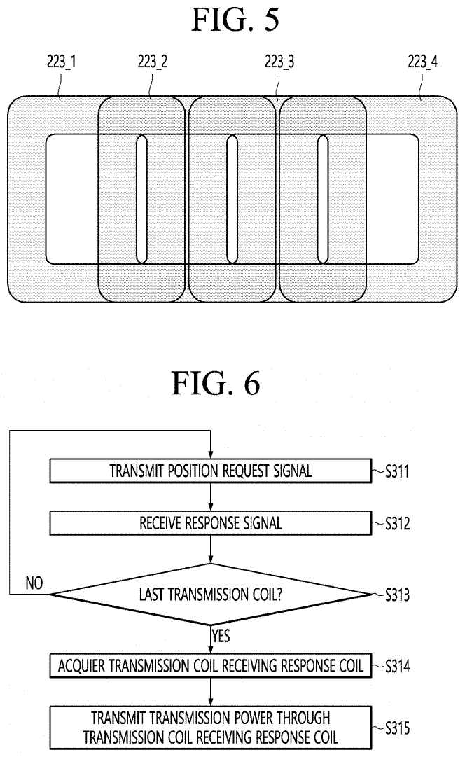

FIG. 5 is a view illustrating a second example of the plurality of transmission coils.

Although FIG. 5 illustrates four transmission coils 223_1 to 223_4, fewer or more transmission coils may be provided.

As illustrated in FIG. 5, the first to fourth transmission coils 223_1 to 223_4 may be disposed along one direction. Each of the first to fourth transmission coils 223_1 to 223_4 may have a rectangular shape. For example, an edge of each of the rectangular transmission coils 223_1 to 223_4 may have a rounded or rectangular shape. Each of the first to fourth transmission coils 223_1 to 223_4 may be wound with a plurality of turns.

The first transmission coil 223_1 and the third transmission coil 223_3 may be disposed to be in contact with each other. The second transmission coil 223_2 and the fourth transmission coil 223_4 may be disposed to be in contact with each other.

For example, the first transmission coil 223_1 and the third transmission coil 223_3 may constitute a first layer, and the second transmission coil 223_2 and the fourth transmission coil 223_4 may constitute a second layer. The second layer may be disposed on the first layer.

For example, a portion of the second transmission coil 223_2 may vertically overlap a portion of the first transmission coil 223_1, and another portion of the second transmission coil 223_2 may vertically overlap a portion of the third transmission coil 223_3. For example, a portion of the fourth transmission coil 223_4 may vertically overlap another portion of the third transmission coil 223_3.

FIG. 6 is a flowchart for explaining an operation method of the wireless power transmission device according to an embodiment.

Referring to FIGS. 3 and 6, the control unit 230 of the wireless power transmission device may transmit the position request signal to the wireless power receiving device (S311).

The control unit 230 may control the plurality of transmission coils 223_1 to 223_n so that the position request signal from each of the plurality of transmission coils 223_1 to 223_n is sequentially transmitted to the wireless power receiving device. For example, the position request signal may be transmitted from the first transmission coil 223_1 to the wireless power receiving device. Subsequently, the position request signal may be transmitted from the second transmission coil 223_2 to the wireless power receiving device. In this manner, the position request signals may be sequentially transmitted to the wireless power receiving device from the first transmission coil 223_1 to the last transmission coil 223_n.

The position request signal may be transmitted periodically. For example, the position request signal may be transmitted from the first transmission coil 223_1 to the last transmission coil 223_n, and after a certain time period, the position request signal may be transmitted from the first transmission coil 223_1 to the last transmission coil 223_n.

The order of the plurality of transmission coils 223_1 to 223_n to transmit the position request signal may be set in advance or set randomly when the corresponding position request signal is transmitted, but is not limited thereto.

The control unit 230 may receive a response signal from the wireless power receiving device (S312).

The response signal may be a signal in response to the transmission power transmitted from each of the plurality of transmission coils 223_1 to 223_n. The response signal may be referred to as a positioning signal. For example, the response signal may be signal strength information or a signal strength indicator. The response signal may include information about the received power received with respect to the transmission power transmitted through a specific transmission coil of the wireless power transmission device.

The control unit 230 may not receive the response signal from the wireless power receiving device. That is, since the wireless power receiving device is disposed far from the specific transmission coil, the position request signal transmitted from the specific transmission coil may not be transmitted to the wireless power receiving device. In this case, since the wireless power receiving device does not receive the position request signal from the specific transmission coil, the response signal to the corresponding position request signal may not be transmitted to the wireless power transmission device. Thus, the wireless power transmission device may not receive the response signal from the wireless power receiving device.

In an embodiment, the position request signal and the response signal may communicate with each other using an in-band communication method, but an out-of-band communication method may also be possible.

The in-band communication method may be a method of communicating by modulating the signal transmitted through the transmission coil or the receiving coil through the pulse modulation method. The out-of-band communication method may be a method in which a communication antenna is provided in each of the wireless power transmission device and the wireless power receiving device to transmit and receive signals through the antenna.

The control unit 230 may acquire whether the position request signal has been transmitted through the last transmission coil 223_n (S313).

The position request signals may be sequentially transmitted from the first transmission coil 223_1 to the last transmission coil 223_n until the position request signal is transmitted through the last transmission coil 223_n.

When the position request signal is transmitted through the last transmission coil 223_n, the control unit 230 may acquire the transmission coil that has received the response signal from the wireless power receiving device (S314).

For example, when the response signal is received from the wireless power receiving device with respect to the position request signal transmitted through the first transmission coil 223_1, the first transmission coil 223_1 may be a transmission coil that has received the response signal.

For example, when the response signal is not received from the wireless power receiving device with respect to the position request signal transmitted through the fourth transmission coil 223_4, the fourth transmission coil 223_4 may be a transmission coil that has not received the response signal.

Thus, the control unit 230 may receive the response signal with respect to a certain transmission coil to acquire the number of transmission coils from which the response signal is received.

The control unit 230 may transmit transmission power to the wireless power receiving device through the transmission coil receiving the response signal (S315).

For example, when the response signal is received from the first transmission coil 223_1, the control unit 230 may transmit the transmission power to the wireless power receiving device through the first transmission coil 223_1.

For example, when the response signal is received for each of the second transmission coil 223_2, the third transmission coil 223_3, and the fourth transmission coil 223_4, the control unit 230 may control the second to fourth transmission coils 223_2 to 223_4 to transmit the transmission power to the wireless power receiving device.

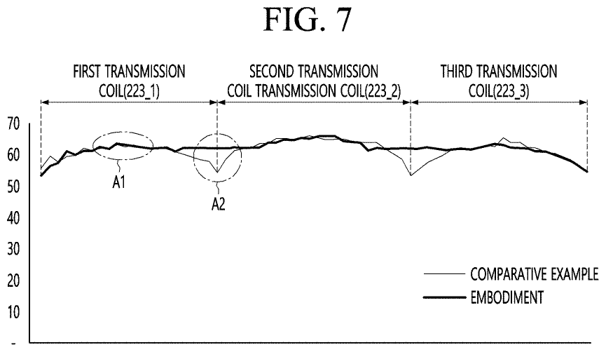

FIG. 7 is a view illustrating charging efficiency along line X1-X2 of FIG. 5 according to a comparative example and an embodiment.

In FIG. 7, although only the first to third transmission coils 223_1 to 223_3 among the first to fourth transmission coils 223_1 to 223_4 of FIG. 5 are illustrated, the fourth transmission coil 223_4 may also have charging efficiency that is the same as or similar to that in the graph shown in FIG. 7. The charging efficiency may be referred to as transmission efficiency. The charging efficiency may be a ratio of the received power received from the wireless power receiving device to the transmission power transmitted from the wireless power transmission device. For example, the charging efficiency of 60% may mean that 60% of the wireless power transmission power is received as the received power by the wireless power receiving device.

In FIG. 7, charging efficiency when the transmission power is transmitted through only one transmission coil according to a comparative example is illustrated, and charging efficiency when the transmission power is transmitted through one transmission coil or each of two or more transmission coils according to the arrangement position of the wireless power receiver according to an embodiment is illustrated.

As illustrated in FIG. 7, the charging efficiency in the comparative example and the embodiment are similar to each other on a central area A1.

However, the charging efficiency in the comparative example and the embodiment are different from each other on a boundary area A2. The boundary area A2 may be an area between adjacent transmission coils. For example, the boundary area A2 may be an area between the first transmission coil 223_1 and the second transmission coil 223_2 or an area between the second transmission coil 223_2 and the third transmission coil 223_3.

In the boundary area A2, the charging efficiency in the embodiment is higher than that in the comparative example. In the comparative example, the charging efficiency is reduced on the boundary area A2 compared to the central area A1. That is, in the comparative example, when the wireless power receiving device is disposed on the boundary area A2, the transmission power may be transmitted through only one of the adjacent transmission coils, and the wireless power receiving device may receive the received power based on the transmission power.

In contrast, in the embodiment, the charging efficiency is the same on the center area A1 and the border area A2. In the embodiment, even if the wireless power receiving device is disposed on the boundary area A2, the transmission power may be transmitted from all the adjacent transmission coils (e.g., all four transmission coils 224_1 to 223_4 when there are four adjacent transmission coils). In addition, the wireless power receiving device may receive the received power based on the transmission power transmitted from all the adjacent transmission coils. Thus, in the boundary area A2, the charging efficiency in the embodiment is significantly greater than the charging efficiency in the comparative example, and thus, a charging time of the wireless power receiving device may be shortened. Therefore, a user may not need to frequently check whether the wireless power receiving device is placed on the transmission coil, thereby enhancing user convenience.

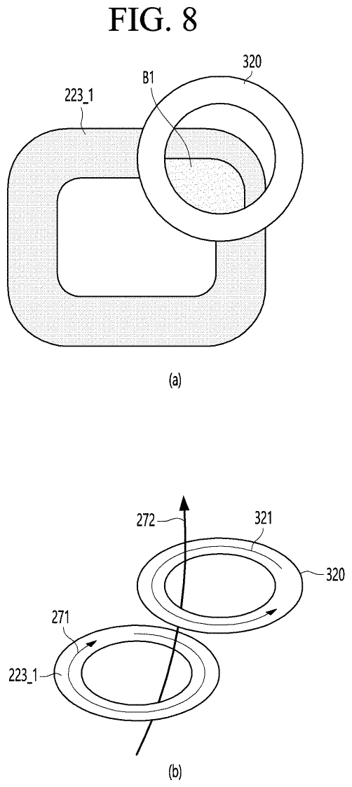

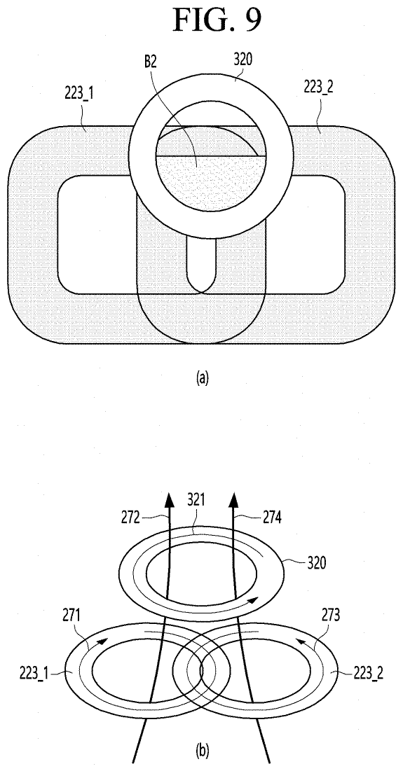

FIG. 8 is a view illustrating a flux area according to the comparative example, and FIG. 9 is a view illustrating a flux area according to the embodiment.

As illustrated in FIG. 8, in the comparative example, the receiving coil 320 of the wireless power receiving device may be deviated from a center of the first transmission coil 323_1 of the wireless power transmitting device, and thus, a center of the receiving coil 320 may be disposed on a coil wound around a hollow of the first transmission coil 323_2. In this case, the wireless power transmission device may transmit the transmission power through the first transmission coil 323_1. A magnetic field flux 272 may be generated by current 271 flowing through the first transmission coil 323_1. Current 321 may flow through the receiving coil 320 of the wireless power receiving device by the magnetic field flux 272 generated by the first transmission coil 323_1, and the received power may be received to the wireless power receiving device based on the current 321.

A flux area B1 may be provided by the magnetic field flux 272 on an area, on which the first transmission coil 323_1 and the receiving coil 320 overlap each other, in the magnetic field flux 272 generated by the first transmission coil 323_1.

As illustrated in FIG. 9, in the embodiment, the receiving coil 320 of the wireless power receiving device may be disposed over, for example, the first transmission coil 323_1 and the second transmission coil 323_2 of the wireless power transmitting device. The center of the receiving coil 320 may be disposed on an area on which the wound coil of the first transmission coil 323_1 and the wound coil of the second transmission coil 323_2 overlap each other. In this case, the wireless power transmission device may transmit the transmission power not only through the first transmission coil 323_1 but also through the second transmission coil 323_2.

The magnetic field flux 272 may be generated by the current 271 flowing through the first transmission coil 323_1, and the magnetic field flux 274 may be generated by the current 273 flowing through the second transmission coil 323_2.

Current 321 may flow through the receiving coil 320 of the wireless power receiving device by the magnetic field flux 272 generated by the first transmission coil 323_1 and the magnetic field flux 274 generated by the second transmission coil 323_2, and the received power may be received to the wireless power receiving device based on the current 321.

A flux area B2 may be provided by the sum of the magnetic field flux 272 on the area, on which the first transmission coil 323_1 and the receiving coil 320 overlap each other, and the area, on which the second transmission coil 323_2 and the receiving coil 320 overlap each other, in the magnetic field fluxes 272 and 274 generated by the current 271 and 273 the first and second transmission coils 323_1 and 323_2. Therefore, the flux area B2 in the embodiment may be larger than the flux area B1 in the comparative example. For example, the flux area B2 in the embodiment may be greater twice than the flux area B1 in the comparative example.

Since the flux area B2 in the embodiment is greater than the flux area B1 in the comparative example, current 321 greater than that in the comparative example may flow through the receiving coil 320 of the wireless power receiving device by the magnetic field fluxes 272 and 274 on the flux area B2, and thus, larger received power may be received.

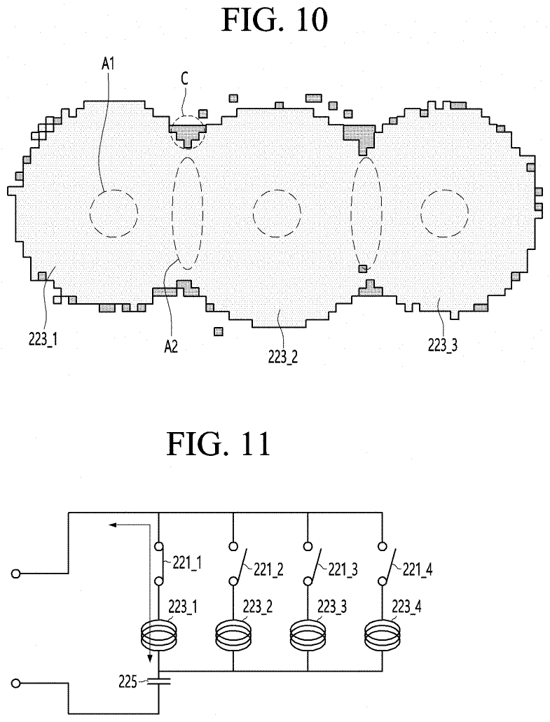

FIG. 10 is a view illustrating charging efficiency according to the comparative example and the embodiment.

As illustrated in FIG. 10, there is no charging efficiency at an edge of the boundary area A2 in the comparative example, but in the embodiment, as illustrated in FIG. 7, an extension area C having charging efficiency that is the same as or similar to that on the boundary area A2 may be provided.

Therefore, when compared to the comparative example, in the embodiment, the higher charging efficiency on the boundary area A2 may be obtained, and the expansion area C that does not exist in the comparative example may be further added. As a result, since the charging area of the wireless power receiving device is further expanded, the wireless power receiver may be charged on the wider charging area to enhance the user's convenience.

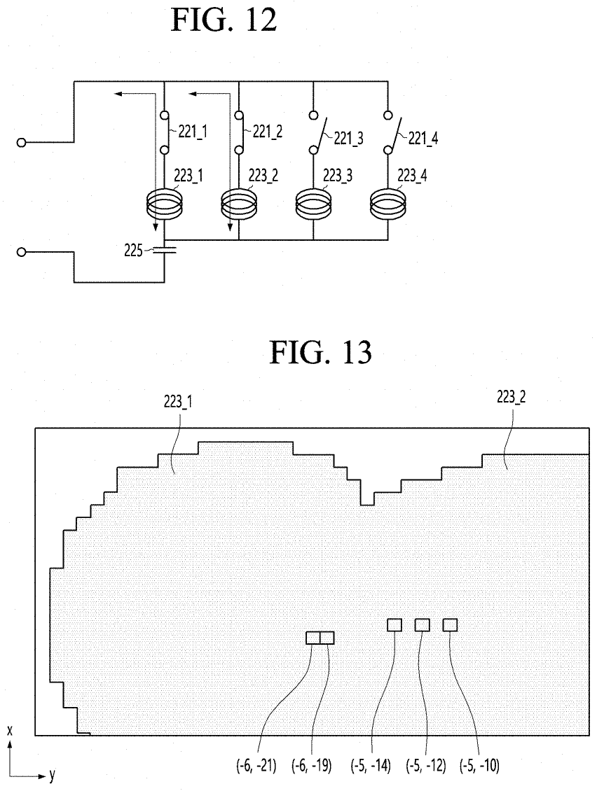

FIG. 11 illustrates that the transmission power is transmitted only through the first transmission coil by turning on the first switch 221_1 in the comparative example, and FIG. 12 illustrates that the transmission power is transmitted through the first and second transmission coils by turning on each of the first and second switches. FIG. 13 is a view illustrating charging efficiency at each coordinate near the boundary area between adjacent transmission coils.

When driven as in the comparative example (see FIG. 11) and the embodiment (see FIG. 12), charging efficiency at each coordinate illustrated in FIG. 13 and an output value of the inverter 213 are shown in Table 1 below.

TABLE 1

| | | Comparative | | | | | |
|---|---|---|---|---|---|---|---|
| | | Example | | Embodiment | | | Vrail |
| | | Charging | | Charging | | Efficiency | Differ- |
| Coordinates | | efficiency | Vrail | efficiency | Vrail | difference | ence |
| x | y | (%) | (V) | (%) | (V) | (%) | (V) |
| −5 | −10 | 51 | 14.70 | 57 | 8.30 | 6 | −6.4 |
| −5 | −12 | 50 | 14.70 | 54 | 9.00 | 4 | −5.7 |
| −5 | −14 | 49 | 13.78 | 55 | 9.30 | 5 | −4.48 |
| −6 | −19 | 54 | 13.20 | 58 | 12.50 | 4 | −0.7 |
| −6 | −21 | 57 | 12.60 | 57 | 12.60 | 0 | 0 |

As shown in Table 1, the charging efficiency is higher in the embodiment compared to the comparative example, and the output voltage Vrail of the inverter 213 may be lower on the boundary area between the adjacent transmission coils. Therefore, in the embodiment, as the charging efficiency increases, a charging time of the wireless power receiving device may be shortened.

In addition, power consumption may be reduced as the output voltage of the inverter 213 is lowered.

In an embodiment, the control unit 230 may differently control an operation frequency as the number of turned-on switches increases. The operation frequency may be a frequency for operating the wireless power receiving device.

When the operation frequency is the same as a resonant frequency, current may rapidly flow in the wireless power transmission device and may damage elements, and thus, the normal operation frequency may be greater than the resonant frequency. When a component that prevents the current from flowing rapidly is provided, the operation frequency may match the resonant frequency.

The resonant frequency may be expressed by Equation 1.

$${f}_{0} = \frac{1}{2 π \sqrt{{L}_{v} C}} \qquad [ Equation 1 ]$$

f0 represents a resonant frequency, Lv represents an inductance that varies depending on the number of transmission coils through which the transmission power is transmitted, and C represents a capacitance of a capacitor 225 (see FIGS. 11 and 12).

In Equation 1, when assuming that the capacitance C of the capacitor 225 has a fixed value, the resonant frequency may vary according to a value of inductance that varies depending on the number of transmission coils through which the transmission power is transmitted.

It is assumed that the inductance of each of the plurality of transmission coils 223_1 to 223_n is, for example, 11.5 pH.

If the first switch 221_1 is turned on, and the transmission power is transmitted through the first transmission coil 223_1, the resonant frequency may be determined by the value of the inductance of the first transmission coil 223_1, that is, 11.5 pH.

If the first and second switches 221_1 and 221_2 are turned on, and the transmission power is transmitted through the first and second transmission coils 223_1 and 223_2, respectively, Lv may be 5.8 pH. That is, it is seen that Lv decreases as the number of transmission coils through which the transmission power is transmitted increases.

Therefore, referring to Equation 1, since Lv decreases as the number of transmission coils increases, the resonant frequency may increase.

For example, if the resonant frequency is 91 kHz when the number of transmission coils through which the transmission power is transmitted is one, the resonant frequency may be 128 kHz when the number of transmission coils through which transmission power is transmitted is two. Thus, the resonant frequency may increase as the number of transmission coils through which the transmission power is transmitted increases.

When the number of transmission coils through which the transmission power is transmitted is one, the operation frequency may be set to be higher than the resonant frequency of 91 kHz. For example, when the number of transmission coils through which the transmission power is transmitted is one, the operation frequency may be 111 kHz.

When the number of transmission coils through which the transmission power is transmitted is two, the operation frequency may be greater than the resonant frequency of 128 kHz. For example, when the number of transmission coils through which the transmission power is transmitted is two, the operation frequency may be 145 kHz.

The operation frequency may be set to be smaller than the resonant frequency. As described above, the operation frequency may be set to coincide with the resonant frequency.

Thus, according to the embodiment, the operation frequency may be set at 0.5 times to 1.5 times the variable (increasing) resonant frequency. For example, when the variable resonant frequency is 128 kHz, the operation frequency may be set at 64 kHz to 192 kHz.

In an embodiment, the operation frequency may be differently set according to the number of turned-on switches. Referring to the operation frequency set as described above, for example, when one switch is turned on, and the transmission power is transmitted through one transmission coil, the control unit 230 may operate the wireless power transmission device at a first operation frequency. For example, when two switches are turned on, and the transmission power is transmitted through each of the two transmission coils, the control unit 230 may operate the wireless power transmission device at a second operation frequency. As described above, as the resonant frequency varies, the operation frequency may also vary in consideration of the resonant frequency, and thus, the wireless power transmission device may be stably operated.

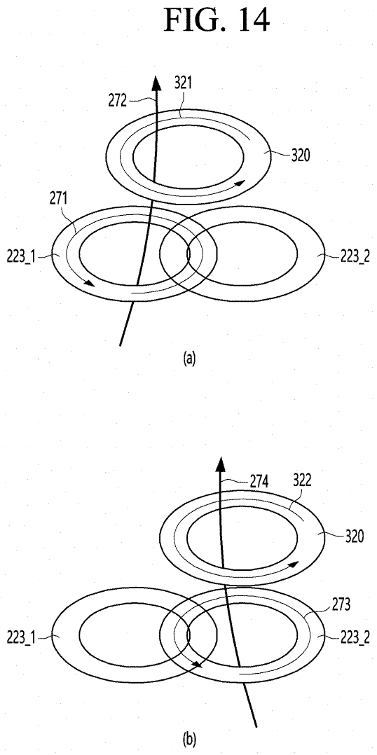

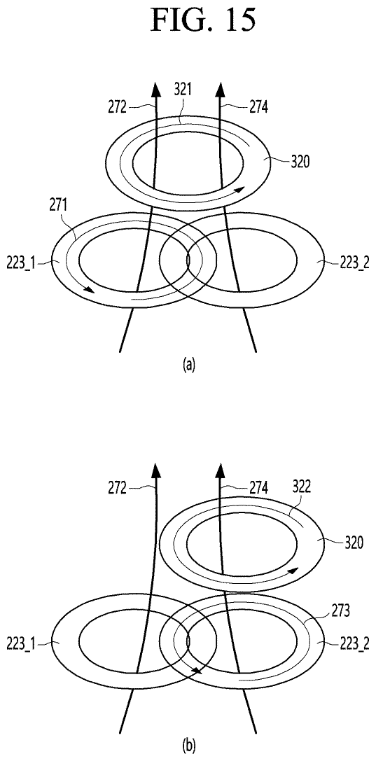

FIG. 14 is a view illustrating a charging operation when the power transmission receiving device moves from the first transmission coil according to the comparative example, and FIG. 15 is a view illustrating a charging operation when the power transmission receiving device moves from the first transmission coil according to an embodiment.

As illustrated in FIG. 14, in the comparative example, while transmitting power through the first transmission coil 223_, on which the wireless power receiving device is placed, among the plurality of transmission coils 223_1 to 223_n (see FIG. 14a), when the wireless power receiving device moves to the second transmission coil 223_2 adjacent to the first transmission coil 223_1 (see FIG. 14b), transmission of the transmission power through the first transmission coil 223_1 may be stopped, and the wireless power transmission device may be restarted. When the wireless power transmission device is restarted to confirm that the wireless power receiving device is placed on the second transmission coil 223_2, the transmission power may be transmitted through the second transmission coil 223_2.

Therefore, in the comparative example, when the first transmission coil 223_1 is deviated from the first transmission coil 223_1 to enter the second transmission coil 223_2, a period for which no transmit power is transmitted to the wireless power receiving device occurs between a time point at which the transmission power transmission through the first transmission coil 223_1 is stopped and a time point at which the transmission power is transmitted through the second transmission coil 223_2, and thus, the wireless power receiver may not be charged for this period, and guide information about a current situation may be output through a display unit or voice for this period to cause user's inconvenience.

As illustrated in FIG. 15, in the embodiment, while the transmitting power through the first transmission coil 223_1, on which the wireless power receiving device is placed, among the plurality of transmission coils 223_1 to 223_n, when the wireless power receiving device is disposed between the first transmission coil 223_1 and the second transmission coil 223_2 (see FIG. 15a), the transmission power may be transmitted through both the first transmission coil 223_1 and the second transmission coil 223_2. Thereafter, when the wireless power receiving device moves to the second transmission coil 223_2 (see FIG. 15b), the transmission power through the first transmission coil 223_1 may be continuous to be transmitted as it is, the wireless power receiver disposed on the second transmission coil 223_2 may be confirmed, and the transmission power may be additionally transmitted through the second transmission coil 223_2.

Therefore, when the wireless power receiving device is placed on the first transmission coil 223_1, it may be charged by the transmission power transmitted through the first transmission coil 223_1, and when moving from the first transmission coil 223_1 to the second transmission coil 223_2, it may be charged by the transmission power transmitted through the second transmission coil 223_2. That is, in the embodiment, even if moving from the first transmission coil 223_1 to the second transmission coil 223_2, a procedure for stopping and restarting the transmission of the transmission power through the first transmission coil 223_1 may not proceed, and the transmission power may be transmitted through the corresponding transmission coil 223_2 to which the wireless power receiving device moves. Therefore, since there is no occurrence of the section in which the transmission power is not transmitted, the charging of the wireless power receiving part may not be interrupted, and the charging may be facilitated, and thus, the information about the discontinuation of the charging may not be provided to the user to remove the inconvenience of the user.

FIGS. 14 and 15, a magnetic field flux 272 may be generated by current 271 flowing through the first transmission coil 223_1, and current 321 may be induced to the receiving coil 320 by the magnetic field flux 272. In addition, a magnetic field flux 274 may be generated by current 273 flowing in the second transmission coil 223_2, and current 322 may be induced to the receiving coil 320 by the magnetic flux 274.

### Arrangement of Multiple Transmission Coils

FIG. 16 is a view illustrating a third example of the plurality of transmission coils.

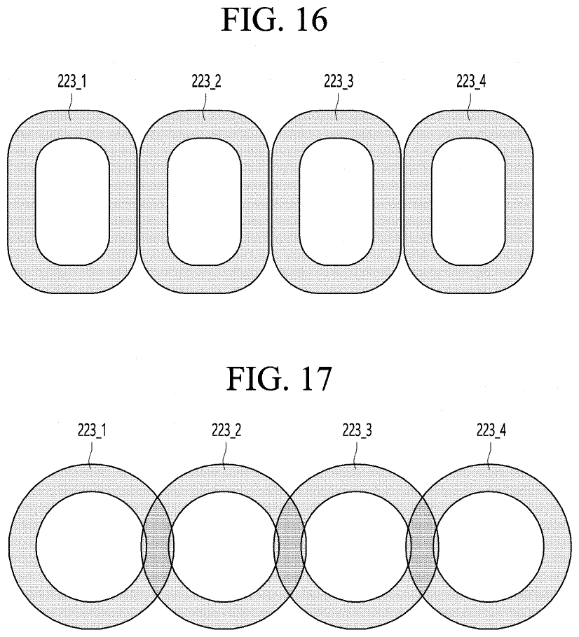

As illustrated in FIGS. 16 to 18, a plurality of transmission coils 223_1 to 223_4 may be disposed along one direction. In this case, each of the transmission coils 223_1 to 223_4 may have an elliptical shape (see FIG. 16), a circular shape (see FIG. 17), and a rectangular shape (see FIG. 18). An edge of each of the rectangular transmission coils 223_1 to 223_4 may have a rounded or rectangular shape.

The plurality of transmission coils 223_1 to 223_4 may be disposed to be in contact with each other (see FIGS. 16 and 18) or overlap each other (see FIG. 17).

As illustrated in FIG. 19, the plurality of transmission coils 223_1 to 223_8 may be arranged in the form of a matrix. For example, the plurality of transmission coils 223_1 to 223_8 may be disposed along a plurality of horizontal directions and a plurality of vertical directions. The plurality of transmission coils 223_1 to 223_8 may be disposed to be in contact with each other, but may also be disposed to overlap each other.

FIG. 19 illustrates the rectangular transmission coil, but the transmission coil having the circular shape or elliptical shape is also possible.

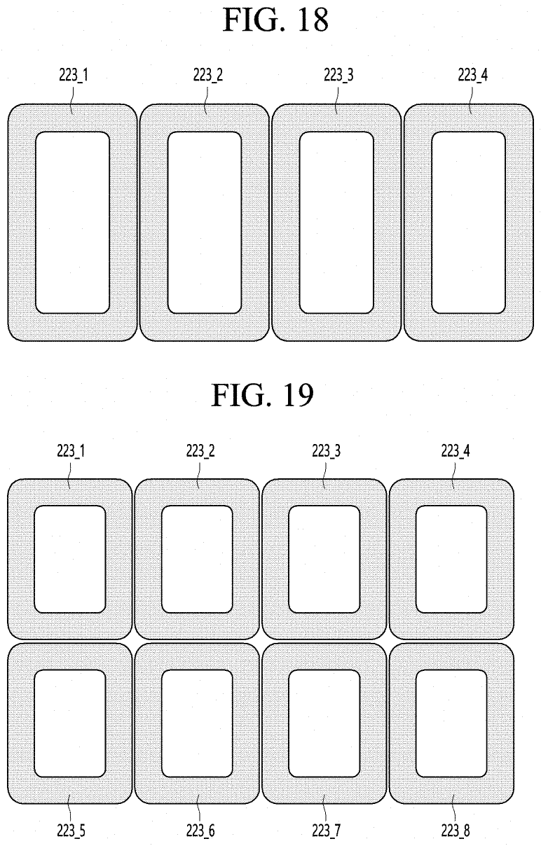

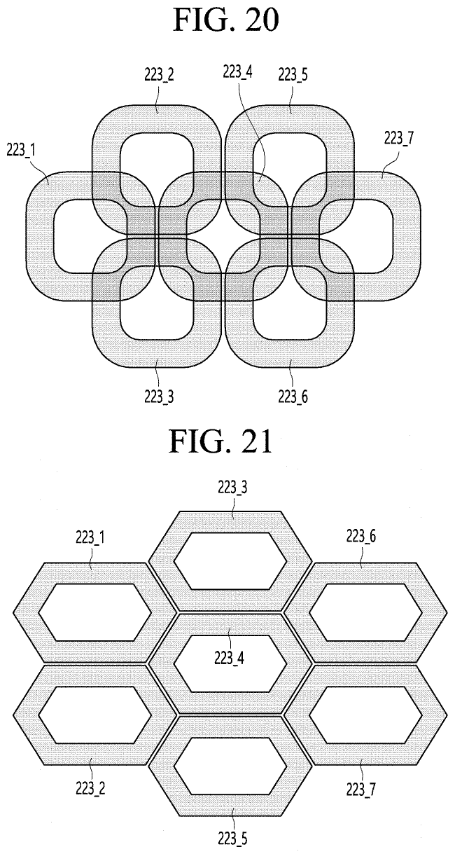

As illustrated in FIGS. 20 and 21, the plurality of transmission coils 223_1 to 223_7 may be arranged in a honeycomb shape.

The plurality of transmission coils 223_1 to 223_7 may overlap each other (see FIG. 20) or may be disposed to be in contact with each other (see FIG. 21).

Each of the plurality of transmission coils 223_1 to 223_7 may have a circular shape, an elliptical shape, or a hexagonal shape.

As illustrated in FIGS. 16 to 18, the plurality of transmission coils 223_1 to 223_4 disposed along one direction may be arranged in a more diverse manner.

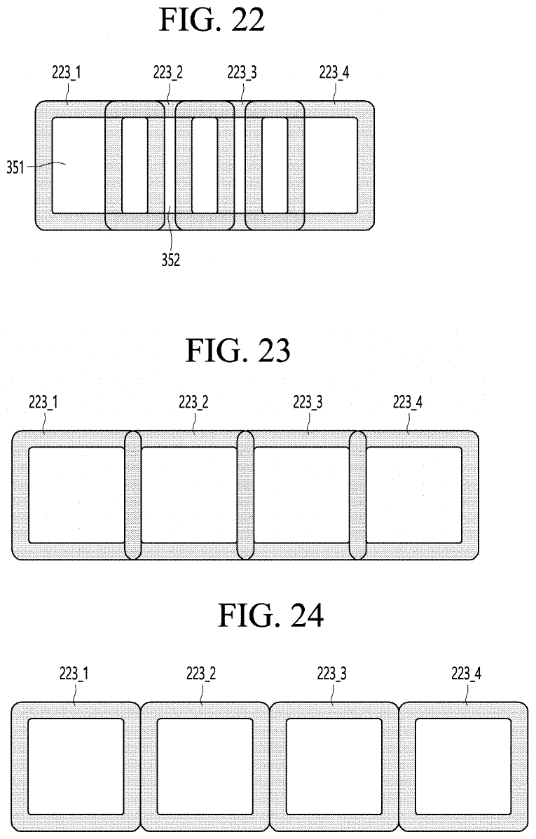

As illustrated in FIG. 22, the plurality of transmission coils 223_1 to 223_4 may be arranged to overlap each other. In addition, in the adjacent first and second transmission coils 223_1 and 223_2, one side of the first transmission coil 223_1 may be disposed in a hollow 352 of the second transmission coil 223_2, and one side of the second transmission coil 223_2 may be disposed in a hollow 351 of the first transmission coil 223_1. In this case, one side of the first transmission coil 223 1 and one side of the second transmission coil 223_2 may be spaced apart from each other.

As illustrated in FIG. 23, the plurality of transmission coils 223_1 to 223_4 may be arranged to overlap each other. In addition, in the adjacent first and second transmission coils 223_1 and 223_2, one side of the first transmission coil 223_1 and one side of the second transmission coil 223_2 may vertically overlap each other.

As illustrated in FIG. 24, the plurality of transmission coils 223_1 to 223_4 may be disposed to be in contact with each other.

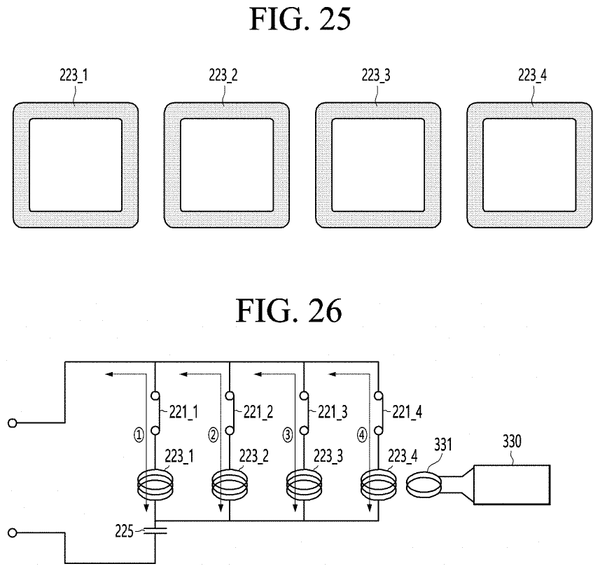

As illustrated in FIG. 25, the plurality of transmission coils 223_1 to 223_4 may be spaced apart from each other.

Thus, as illustrated in FIGS. 22 to 25, the plurality of transmission coils 223_1 to 223_4 may overlap each other, be in contact each other, or be spaced apart from each other.

As an area on which the plurality of transmission coils 223_1 to 223_4 overlap each other increases, the number of transmission coils per unit area may increase, and as a distance between the plurality of transmission coils 223_1 to 223_4 increases, the number of transmission coils per unit area may decrease.

For example, the plurality of transmission coils may be disposed by increasing in distance between the plurality of transmission coils 223_1 to 223_4 in order to expand a charging area of the wireless power receiving device and reduce coil costs.

FIG. 26 is a view illustrating a charging operation of a wearable device as the wireless power receiving device.

Referring to FIGS. 3 and 26, when the wireless power receiving device is a wearable device 330, the control unit 230 may allow a resonant frequency to increase so as to match a resonant frequency of the wearable device 330 by sequentially increasing in number of turned-on switches.

For example, the wireless power receiving device may be mounted on the wearable device 330, and the wearable device 330 may be charged by transmission power transmitted from the wireless power transmission device.

In an embodiment, the wireless power transmission device may be mounted on, for example, a vehicle. In this case, a diameter of each of the plurality of transmission coils 223_1 to 223_4 of the wireless power transmission device, for example, an outer diameter, may be large.

In contrast, since a size of the wearable device 330 is small, an outer diameter of the receiving coil 331 of the wearable device 330 is also small. That is, the outer diameter of the receiving coil 331 of the wearable device 330 may be very small when compared to each of the transmission coils 223_1 to 223_4 of the wireless power transmission device. In this case, the resonant frequency of the wearable device 330 may be very high when compared to the resonant frequency of the wireless power receiving device. As described above, as a difference in resonant frequency between the wireless power transmission device and the wearable device 330 is large, transmission efficiency (charging efficiency) between the wireless power transmission device and the wearable device 330 may be significantly deteriorated.

In order to solve this problem, in the embodiment, the transmission power may be sequentially transmitted through each of the plurality of transmission coils 223_1 to 223_4, and thus, the resonant frequency of the wireless power transmission device may sequentially increase. In the operation of sequentially transmitting the transmission power through each of the plurality of transmission coils 223_1 to 223_4, the resonant frequency increasing by the increase in the number of transmission coils through which the transmission electricity is transmitted may match the resonant frequency of the wearable device 330 or may be continuous until the resonant frequency approaches the resonant frequency of the wearable device 330.

When four transmission coils 223_1 to 223_4 are provided, the transmission power may be transmitted through, for example, the first transmission coil 223_1 (\textcircled{1}). In this case, when the resonant frequency of the wireless power transmission device is smaller than the resonant frequency of the wearable device 330, the transmission power may be transmitted through the second transmission coil 223_2 (\textcircled{2}). The transmission power may be transmitted through each of the first and second transmission coils 223_1 and 223_2, and when the resonant frequency at this time is smaller than the resonant frequency of the wearable device, the transmission power may be transmitted through the third transmission coil 223_3 (\textcircled{3}). Thus, the transmission power may be transmitted through each of the first to third transmission coils 223_1 to 223_3. Here, when the resonant frequency matches or approaches that of the wearable device 330, the transmission of the transmission power through the fourth transmission coil 223_4 may not proceed any more, and the transmission power may be continuously transmitted through each of the first to third transmission coils 223_1 to 223_3. The wearable device 330 may be charged by the transmission power transmitted through each of the first to third transmission coils 223_1 to 223_3. Even if the transmission power is transmitted through the third transmission coil 223_3, when the resonant frequency does not match or approach that of the wearable device 330, the transmission power may be transmitted through the fourth transmission coil 223_4 (\textcircled{4}).

Although the transmission power is transmitted through each of the first to third transmission coils 223_1 to 223_3, when the wearable device 330 is disposed between the first and second transmission coils 223_1 and 223_2, a magnetic field flux generated by the third transmission coil 223_3 may not contribute to the wearable device 330, but a magnetic field flux generated by each of the first and second transmission coils 223_1 and 223_2 may contribute to the wearable device 330. Thus, the wearable device 330 may be charged by the magnetic field flux generated by each of the first and second transmission coils 223_1 and 223_2.

Although the magnetic field flux generated by the third transmitting coil 223_3 does not contribute to the wearable device 330, since an inductance of the third transmission coil 223_3 increases to contributes so that the resonant frequency of the wireless power transmission device matches or approaches the resonant frequency of the wearable device 330, the third transmission coil 223_3 may transmit the transmission power together with the first and second transmission coils 223_1 and 223_2.

In order to match the resonant frequency of the wireless power transmission device with the resonant frequency of the wearable device 330, an order of transmitting the transmission power in the plurality of transmission coils 223_1 to 223_4 may be determined according to a preset order or an arrangement position of the wearable device 330. For example, the transmission power may be sequentially transmitted from the first transmission coil 223_1. For example, the arrangement position of the wearable device 330 may be acquired based on a signal strength indicator received from the wearable device 330, and the transmission power may be set to be sequentially transmitted from the transmission coil on an area, on which the acquired wearable device 330 is disposed, to the transmission coil on a peripheral area.

The detailed description is intended to be illustrative, but not limiting in all aspects. It is intended that the scope according to the embodiment should be determined by the rational interpretation of the claims as set forth, and the modifications and variations according to the embodiment come within the scope of the appended claims and their equivalents.

### INDUSTRIAL APPLICABILITY

Embodiments may be variously applied not only to mobiles, but also to various industries such as IT, vehicles, railroads, and home appliance industries.

1. A wireless power transmission device comprising:
a plurality of transmission coils; and
a control unit,
wherein the plurality of transmission coils are disposed in one direction, disposed in a matrix form, or disposed in a honeycomb shape, and
the control unit is configured to control transmission power to be transmitted from at least one or more transmission coils of the plurality of transmission coils to a wireless power receiving device according to a position at which the wireless power receiving device placed on the plurality of transmission coils is disposed,
wherein the plurality of transmission coils is controlled to transmit a position request signal to the wireless power receiving device when the wireless power receiving device is placed on the plurality of transmission coils, and
the position request signal is sequentially transmitted to the wireless power receiving device from the first transmission coil to the last transmission coil of the plurality of transmission coils.

2. The wireless power transmission device according to claim 1, wherein the control unit is configured to:
transmit the transmission power through the transmission coil that receives a response signal with respect to the position request signal from the plurality of transmission coils.

3. The wireless power transmission device according to claim 2, wherein the control unit is configured to:
acquire the position at which the wireless power receiving device is disposed based on a signal strength indicator contained in the response signal in the transmission coil that receives the response signal among the plurality of transmission coils; and
control the transmission power to be transmitted through at least one or more transmission coils among the plurality of transmission coils according to the acquired position at which the wireless power receiving device is disposed.

4. The wireless power transmission device according to claim 3, further comprising:
an inverter configured to convert a DC voltage to an AC voltage - each of the plurality of transmission coils is connected in parallel to the inverter; and
a switch connected in series to each of the plurality of transmission coils.

5. The wireless power transmission device according to claim 4, wherein the control unit is configured to turn on a first switch connected to a first transmission coil so as to transmit the transmission power through the first transmission coil when the response signal with respect to the position request signal from the first transmission coil among the plurality of transmission coils is received.

6. The wireless power transmission device according to claim 5, wherein the control unit is configured to turn on a switch connected to each of two or more transmission coils so as to control the transmission power to be transmitted through each of the two or more transmission coils when the response signal with respect to the position request signal from each of the two or more transmission coils among the plurality of transmission coils is received.

7. The wireless power transmission device according to claim 6, wherein, as the number of turned-on switches increases, a resonant frequency increases, and
the control unit is configured to differently control an operation frequency as the number of turned-on switches increases.

8. The wireless power transmission device according to claim 7, wherein the operation frequency is set at 0.5 times to 1.5 times the increasing resonant frequency.

9. The wireless power transmission device according to claim 4, wherein the control unit is configured to allow the resonant frequency to increase so that the number of turn-on switches to sequentially increase to match a resonant frequency of a wearable device when the wireless power receiving device is the wearable device.

10. The wireless power transmission device according to claim 1, wherein the control unit is configured to transmit the transmission power through each of first and second transmission coils when the wireless power receiving device enters the second transmission coil adjacent to the first transmission coil while transmitting the transmission power through the first transmission coil, on which the wireless power receiving device is placed, among the plurality of transmission coils.

11. The wireless power transmission device according to claim 1, wherein the control unit is configured to transmit the transmission power through each of first to third transmission coils when the wireless power receiving device enters the second and third transmission coils adjacent to the first transmission coil while transmitting the transmission power through the first transmission coil, on which the wireless power receiving device is placed, among the plurality of transmission coils.

12. The wireless power transmission device according to claim 1, wherein, when the plurality of transmission coils are disposed in one direction, the transmission coils adjacent to each other are disposed to overlap each other.

13. The wireless power transmission device according to claim 1, wherein, when the plurality of transmission coils are disposed in one direction, the transmission coils adjacent to each other are disposed to be in contact with each other.

14. The wireless power transmission device according to claim 1, wherein, when the plurality of transmission coils are disposed in one direction, the transmission coils adjacent to each other are disposed to be spaced apart from each other.

15. The wireless power transmission device according to claim 1, wherein the transmission coil has a circular shape, an elliptical shape, a rectangular shape, or a hexagonal shape.

16. The wireless power transmission device according to claim 15, wherein an edge of the transmission coil having the rectangular shape has a rounded or right-angled shape.

17. The wireless power transmission device according to claim 1, wherein the plurality of transmission coils are provided to be patterned on a printed circuit board.

18. The wireless power transmission device according to claim 1, wherein the transmission coil has an outer diameter greater than that of a receiving coil.

19. A vehicle including a wireless power transmission device comprising:
a plurality of transmission coils; and
a control unit,
wherein the plurality of transmission coils are disposed in one direction, disposed in a matrix form, or disposed in a honeycomb shape, and
the control unit is configured to control transmission power to be transmitted from at least one or more transmission coils of the plurality of transmission coils to a wireless power receiving device according to a position at which the wireless power receiving device placed on the plurality of transmission coils is disposed,
wherein the plurality of transmission coils is controlled to transmit a position request signal to the wireless power receiving device when the wireless power receiving device is placed on the plurality of transmission coils, and
the position request signal is sequentially transmitted to the wireless power receiving device from the first transmission coil to the last transmission coil of the plurality of transmission coils.
